(19) United States
(12) Patent Application Publication
(10) Pub. No.: US 2026/0099729 A1
(43) Pub. Date: Apr. 9, 2026

(54) COMPOUND DOCKING CALCULATION PROCESSING DEVICE, COMPOUND DOCKING CALCULATION PROCESSING METHOD, AND PROGRAM

(71) Applicants: INSTITUTE OF SCIENCE TOKYO, Tokyo (JP); Ahead Biocomputing, Co. Ltd., Kawasaki-shi Kanagawa (JP); Toshiba Digital Solutions Corporation, Kawasaki-shi Kanagawa (JP)

(72) Inventors: Keisuke Yanagiasawa, Tokyo (JP); Yutaka Akiyama, Kawasaki-shi (JP); Takuya Fujie, Kawasaki-shi (JP); Kazuki Takabatake, Chiba Chiba (JP)

(73) Assignees: INSTITUTE OF SCIENCE TOKYO, Tokyo (JP); Ahead Biocomputing, Co. Ltd., Kawasaki-shi Kanagawa (JP); Toshiba Digital Solutions Corporation, Kawasaki-shi Kanagawa (JP)

(21) Appl. No.: 19/349,468

(22) Filed: Oct. 3, 2025

(30) Foreign Application Priority Data
Oct. 7, 2024 (JP) 2024-176184

(51) Int. Cl. G06N 5/01

(52) U.S. Cl. CPC G06N 5/01

(57) ABSTRACT

[Object] To enable combinatorial optimization in fragment-based compound docking calculation.

[Solution] A compound docking calculation processing device includes a fragment decomposition unit configured to acquire fragment data indicating fragments of a compound used to perform docking calculation with a target biomolecule, a fragment docking calculation unit configured to execute fragment docking calculation for each fragment, a fragment interaction evaluation unit configured to calculate evaluation values for the fragment placement candidates and the interrelationship between the fragment placement candidates based on the result of fragment docking calculation for each fragment placement candidate and the positional relationship between fragment placement candidates, an evaluation function generation unit configured to generate an evaluation function of giving an evaluation value for a fragment pose set based on the evaluation value, and a combinatorial optimization calculation processing unit configured to calculate a fragment pose set by determining a state that optimize the evaluation function based on combinatorial optimization.

### BACKGROUND OF THE INVENTION

### Field of the Invention

The present invention relates to a compound docking calculation processing device, a compound docking calculation processing method, and a program.

### Description of Related Art

In drug discovery, computational methods are widely used to improve efficiency. Among them, structure-based drug design (SBDD) is a method of searching for drug candidate compounds using three-dimensional structural information of biomolecules such as target proteins. Compared to ligand-based drug design (LBDD), which searches for drug candidate compounds with reference to features of known active compounds of biomolecules such as target proteins, SBDD enables the selection of drugs with new structures.

As a method of realizing SBDD, a method of performing docking calculations between biomolecules such as target proteins and druggable compounds has become increasingly important. As the number of druggable compounds has increased rapidly in recent years, there is a growing demand for realizing high-speed docking calculation with compounds. In docking calculation, it is necessary to consider rotation and translation of the entire compound within the binding site of biomolecules such as target proteins, and the compound has multiple internal degrees of freedom due to some rotatable covalent bonds. Even with conventional techniques, a process for a compound can be completed in about several tens of seconds, but if there are hundreds of millions of compounds to be evaluated, the calculation time becomes so long that practical processing is no longer feasible.

In recent years, the concept of ultra-large-scale compound libraries has emerged, and with the rise of generative deep learning, virtually generated compounds can also become drug candidates, and accordingly, there is a demand to perform docking calculations on a huge number of compounds, ranging from hundreds of millions to billions. Currently, it is not possible to perform docking calculations on such a huge number of compounds. Therefore the number of candidates is reduced through simpler selection, but increasing the number of compounds that can be subjected to docking calculation is considered important to avoid missing beneficial drug candidate compounds.

On the other hand, “fragment-based compound docking” calculation is known as a method of realizing high-speed docking calculation with a huge number of compounds to be evaluated. In fragment-based compound docking calculation, a compound is decomposed into substructures called fragments, fragment docking calculation is then performed between the fragments and a biomolecule such as target protein, and the docking calculation result for the compound before it is decomposed is obtained by combining the fragment docking calculation results for each fragment.

The method of decomposing a compound into fragments is not unique, but it is common to decompose the compound such that the fragments have no internal degrees of freedom, and there are standard decomposition techniques. Although it is easy to perform docking calculation on the fragments after decomposition such that they have no internal degrees of freedom, the fragment placement candidates obtained as a result of the fragment docking calculation are highly likely to take positions where they collide with each other or positions where covalent bonding with other fragments is not possible. Therefore it is necessary to select a consistent combination (perform “combinatorial optimization”) from among various placement candidates of the fragments that are the fragment docking calculation results, which can be said to make the problem complex. Nevertheless, fragment-based compound docking calculation remains highly attractive because compounds in drug discovery are created through partial substitution from known compounds, and thus they have very similar structures, and the number of unique fragments constituting the compounds is relatively small. However, in conventional fragment-based compound docking calculation methods, even when the fragment groups constituting the compounds are similar to each other, since the intermediate calculation results are discarded and all calculations are performed again for each compound, the calculation time proportional to the number of compounds is required. On the other hand, in fragment-based compound docking calculation in which docking calculation is first performed on a relatively small number of fragments and these are then appropriately combined, it is possible to perform processing at a higher speed compared to conventional methods which require a calculation time proportional to the number of compounds.

In fragment-based compound docking calculation, it is necessary to perform combinatorial optimization calculation. In conventional techniques, combinatorial optimization is reduced to a graph-theoretical problem known as the maximum clique problem and solved using classical algorithms (Non-Patent Document 1). In addition, another conventional technique uses a method in which the process of searching for consistent combinations is completely avoided, a plurality of “possible conformations” are generated externally for each compound, and the information about the generated “possible conformations” is utilized (Non-Patent Document 2).

### Non-Patent Documents

[Non-Patent Document 1] “Journal of Molecular Graphics and Modelling,” July 2007, Vol. 26, No. 1, p. 198-212
[Non-Patent Document 2] “ACS Omega,” Aug. 19, 2022, Vol. 7, No. 34, p. 30265-30274
[Non-Patent Document 3] “Bioinformatics,” Mar. 30, 2017, Vol. 33, No. 23, p. 3836-3843
[Non-Patent Document 4] “Journal of Chemical Information and Modeling,” Jul. 19, 2021, Vol. 61, No. 8, p. 3891-3898 [Non-Patent Document 5] “Entropy,” Feb. 28, 2022, Vol. 24, No. 3, p. 354

### SUMMARY OF THE INVENTION

As described above, the potential demand of fragment-based compound docking calculation is rapidly increasing in response to the increase in size of compound libraries, and there is a strong need to perform combinatorial optimization calculations inherent in fragment-based compound docking calculation. The purpose of this combinatorial optimization is to select appropriate sets (fragment pose sets) of fragment placement candidates that constitute a compound and are compatible with each other from a group of possible candidates on the surface of a target biomolecule.

The present invention has been made in view of the above circumstances, and provides a compound docking calculation processing device, a compound docking calculation processing method, and a program through which combinatorial optimization can be performed in fragment-based compound docking calculation.

A compound docking calculation processing device according to an embodiment includes a fragment decomposition unit, a fragment docking calculation unit, a fragment interaction evaluation unit, an evaluation function generation unit, and a combinatorial optimization calculation processing unit. The fragment decomposition unit acquires fragment data indicating fragments, which are chemical substructures of a compound used to perform fragment docking calculation with a target biomolecule. The fragment docking calculation unit executes, for each fragment indicated by the fragment data, fragment docking calculation between the fragment and the target biomolecule. The fragment interaction evaluation unit calculates, based on the result of fragment docking calculation for each fragment placement candidate which is a placement candidate when the fragment binds to the target biomolecule and a positional relationship between the fragment placement candidates, evaluation values for the fragment placement candidates and the interrelationship between the fragment placement candidates. The evaluation function generation unit generates an evaluation function of giving an evaluation value for a fragment pose set of the fragments constituting the compound on the surface of the target biomolecule based on the evaluation value. The combinatorial optimization calculation processing unit calculates a fragment pose set of the fragments constituting the compound on the surface of the target biomolecule by determining a state that optimizes the evaluation function based on combinatorial optimization.

### BRIEF DESCRIPTION OF THE DRAWINGS

FIG. 1 is a diagram showing an example of a functional configuration of a calculation processing device 1 according to a first embodiment of the present invention.

FIG. 2 is a diagram showing an example of the processing content of respective functional units of the calculation processing device 1 according to the first embodiment of the present invention.

FIG. 3 is a diagram showing an example of a comparison between a polyomino puzzle and a fragment-based compound docking calculation according to the first embodiment of the present invention.

FIG. 4 is a diagram showing an example of a comparison between a polyomino puzzle and a fragment-based compound docking calculation in terms of representation of binary variables, fitness of elements, collision between elements, cooperation between elements, and the number of selected elements according to the first embodiment of the present invention.

FIG. 5 is a diagram showing an example of a comparison between a polyomino puzzle and a fragment-based compound docking calculation in terms of collision between elements according to the first embodiment of the present invention.

FIG. 6 is a diagram showing an example of a comparison between a polyomino puzzle and a fragment-based compound docking calculation in terms of cooperation between elements according to the first embodiment of the present invention.

FIG. 7 is a diagram showing an example of a flow of a fragment-based compound docking calculation process according to the first embodiment of the present invention.

FIG. 8 is a diagram showing an example of how fragment placement candidates are obtained from fragment data by fragment docking calculation according to the first embodiment of the present invention.

FIG. 9 is a diagram showing an example of how a Hamiltonian is generated according to the first embodiment of the present invention.

FIG. 10 is a diagram showing an example of how a Hamiltonian is minimized by combinatorial optimization using a quasi-quantum annealer according to the first embodiment of the present invention.

FIG. 11 is a diagram showing an example of how covalent bonds are formed between fragments according to the first embodiment of the present invention.

FIG. 12 is a diagram showing the structures of a target protein and a compound according to an example of the first embodiment of the present invention.

FIG. 13 is a diagram showing docking calculation parameters according to an example of the first embodiment of the present invention.

FIG. 14 is a diagram showing the results of docking calculation using each fragment according to an example of the first embodiment of the present invention.

FIG. 15 is a diagram showing the number of fragment placement candidates obtained as a result of docking calculation using each fragment according to an example of the first embodiment of the present invention and the maximum value and the minimum value of these binding free energy scores.

FIG. 16 is a diagram showing the distribution of binding free energy scores for fragments according to an example of the first embodiment of the present invention.

FIG. 17 is a diagram showing the distribution of binding free energy scores for fragments according to an example of the first embodiment of the present invention.

FIG. 18 is a diagram showing the distribution of binding free energy scores for fragments according to an example of the first embodiment of the present invention.

FIG. 19 is a diagram showing the distribution of binding free energy scores for fragments according to an example of the first embodiment of the present invention.

FIG. 20 is a scatter plot of Hamiltonian values after combinatorial optimization calculation is performed and RMSDs relative to the correct structure of docking calculation according to an example of the first embodiment of the present invention.

FIG. 21 is a diagram showing a fragment pose set for the best solution among local optimum solutions in combinatorial optimization calculation according to an example of the first embodiment of the present invention.

FIG. 22 is a diagram showing the results of docking calculation with a compound after local structure optimization is performed according to an example of the first embodiment of the present invention.

FIG. 23 is a diagram showing an example of a functional configuration of a calculation processing device 1a according to a second embodiment of the present invention.

FIG. 24 is a diagram showing an example of the processing content of respective functional units of the calculation processing device 1a according to the second embodiment of the present invention.

FIG. 25 is a diagram showing an example of a flow of a fragment-based compound docking calculation process according to the second embodiment of the present invention.

### DETAILED DESCRIPTION OF THE INVENTION

### First Embodiment

An embodiment of the present invention will be described below in detail with reference to the drawings.

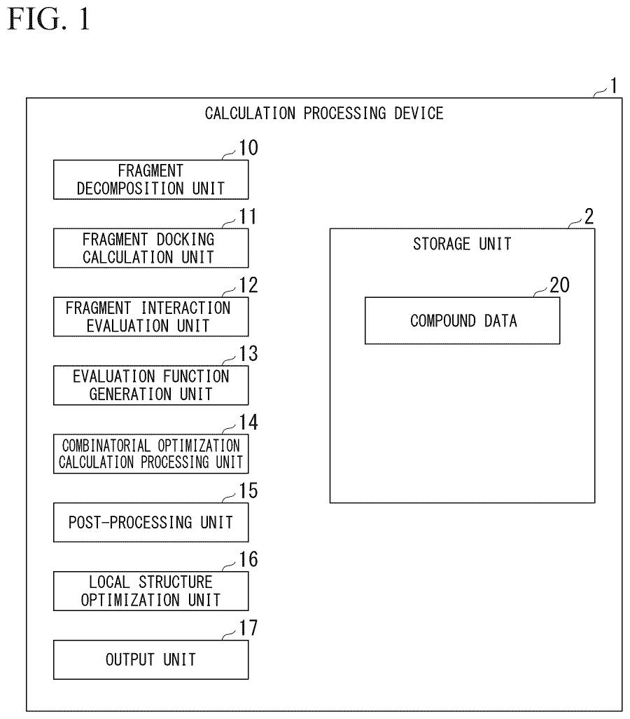

A compound docking calculation processing device according to the present embodiment is called a calculation processing device 1. FIG. 1 is a diagram showing an example of a functional configuration of the calculation processing device 1 according to the present embodiment. The calculation processing device 1 is a device that performs fragment-based compound docking calculation based on combinatorial optimization. The purpose of this combinatorial optimization is to select appropriate sets (fragment pose set) of fragment placement candidates that constitute a compound and are compatible with each other from a group of possible candidates on the surface of a target biomolecule, which is a biomolecule serving as a target.

Here, in the present embodiment, the bond may be either a covalent bond or a non-covalent bond. Non-covalent bonds include, for example, electrostatic interactions, van der Waals forces, and hydrophobic interactions.

The calculation processing device 1 includes a fragment decomposition unit 10, a fragment docking calculation unit 11, a fragment interaction evaluation unit 12, an evaluation function generation unit 13, a combinatorial optimization calculation processing unit 14, a post-processing unit 15, a local structure optimization unit 16, an output unit 17, and a storage unit 2. The fragment decomposition unit 10, the fragment docking calculation unit 11, the fragment interaction evaluation unit 12, the evaluation function generation unit 13, the combinatorial optimization calculation processing unit 14, the post-processing unit 15, the local structure optimization unit 16, and the output unit 17 are each realized, for example, by a CPU loading a program from a read only memory (ROM) into a random access memory (RAM), and executing processing according to the program. The ROM and the RAM are incorporated into the storage unit 2.

The storage unit 2 stores various types of information. As an example, the storage unit 2 stores compound data 20. The compound data 20 is data indicating a compound. The storage unit 2 is configured using a storage device such as a magnetic hard disk device or a semiconductor storage device. Here, the compound data 20 may be stored in a database provided outside the calculation processing device 1.

Here, the calculation processing device 1 may be realized as a single computer or may be realized as a virtual server. Respective functional units of the calculation processing device 1 may be distributed across a plurality of servers. The calculation processing device 1 may be realized as a cloud server.

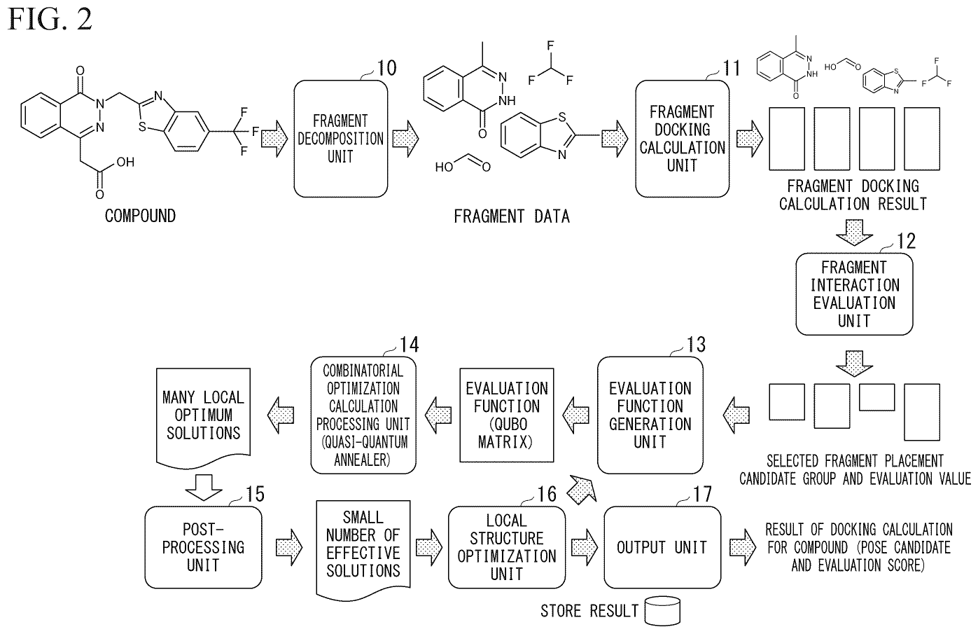

Here, respective functional units of the calculation processing device 1 will be described with reference to FIG. 2. FIG. 2 is a diagram showing an example of the processing content of respective functional units of the calculation processing device 1 according to the present embodiment. In the present embodiment, in the compound docking calculation performed by the calculation processing device 1, the number of compounds input is one, and the output is the result of docking calculation for the compound with respect to a target biomolecule. Target biomolecules are, for example, proteins (referred to as target proteins). Here, the target biomolecules may be biopolymers such as nucleic acids and nucleic acid protein complex or biological molecules. An example in which the target biomolecules are target proteins will be described below. The docking calculation results include pose candidates in which the compound binds to a target protein and evaluation scores for the pose candidates. Here, in the description of FIG. 2, as an example, the compound is assumed to be composed of four fragments.

The fragment decomposition unit 10 decomposes a compound into fragments. Fragment data, which is data indicating fragments, is generated through the decomposition by the fragment decomposition unit 10. A fragment is a chemical substructure of the compound. In the present embodiment, fragments are assumed to have no internal degrees of freedom. The internal degrees of freedom refer to the degrees of freedom in which some covalent bonds can rotate. As an example, the fragment decomposition unit 10 decomposes a compound into fragments based on the decomposition method described in Non-Patent Document 3, and acquires fragment data generated through the decomposition. Here, the fragment decomposition unit 10 may use another decomposition method for the decomposition. The fragment decomposition unit 10 may acquire fragment data generated by an information processing device separate from the calculation processing device 1 from the information processing device.

Here, when the original compound is decomposed into fragments, it is possible to connect a capping atom to each atom at both ends of the cleaved covalent bond. The cap indicates the presence of an atom or atom group at the cap position. In addition, the cap may also be used as a potential covalent bond point (attachment point) when the cooperation between fragments to be described below is evaluated.

The fragment docking calculation unit 11 executes, for the fragment indicated by the fragment data, docking calculation between the fragment and the target protein.

Thereby, the fragment docking calculation unit 11 obtains the fragment docking calculation result for each fragment. The fragment docking calculation results are a group of fragment placement candidates on the target protein with respect to the fragment and the fragment docking score for each fragment placement candidate. The fragment placement candidate is a placement candidate in which a fragment binds to a target protein. This placement is specified by the orientation of the fragment and the position of the fragment in a three-dimensional space. Here, a fragment placement candidate is also referred to as a fragment pose.

The fragment docking calculation unit 11 executes fragment docking calculation with a target protein for each fragment group (as an example, four fragments) indicated by the fragment data. In the fragment docking calculation, a known docking calculation algorithm and a known docking score calculation method may be used. As an example, the fragment docking calculation unit 11 uses, as a docking calculation algorithm, a predetermined algorithm, which comprehensively performs rotation and translation of the fragment. In addition, as an example, the fragment docking calculation unit 11 uses the parameters described in Non-Patent Document 4 as the docking score calculation method to obtain an evaluation value of the interaction energy. Here, the interaction energy is the energy of interaction between each fragment and a target protein.

In the process described below, in order to execute combinatorial optimization between fragment placement candidates, if the parameters specifying rotation and translation are changed too finely, the number of fragment placement candidates may become too large. Accordingly, in the above predetermined algorithm, it is possible to perform adjustment so that the amount of change in the parameters specifying rotation and translation is equal to or larger than a predetermined amount.

Here, in this case, in order to provide diversity to candidates selected by the fragment interaction evaluation unit 12 to be described below, the fragment docking calculation unit 11 may perform fragment docking calculation a plurality of times independently for each sub-region in the binding site, instead of performing fragment docking calculation once for the entire binding site. For example, the binding site of the target protein may be divided into cubic regions with sides of 2 Å, and the fragment docking calculation may be performed independently for each region. In this case, in the process performed by the fragment interaction evaluation unit 12, the fragment docking calculation results for each region can be handled based on independent criteria. As another example, in the process performed by the fragment interaction evaluation unit 12, it is also possible to retain fragment placement candidates from the fragment docking calculation results for the entire target protein in consideration of the position diversity.

The fragment interaction evaluation unit 12 calculates evaluation values for the fragment placement candidates and the interrelationship between the fragment placement candidates based on the fragment docking score for each fragment placement candidate and the positional relationship between fragment placement candidates. The positional relationship between fragment placement candidates includes a collision between the fragment placement candidates and cooperation between the fragment placement candidates.

In the present embodiment, the fragment interaction evaluation unit 12 executes the above process as a linear evaluation process and a quadratic evaluation process for the fragment docking calculation results obtained by the fragment docking calculation unit 11. In the linear evaluation process, for a huge number of fragment placement candidate groups, the contribution of each fragment placement candidate to the interaction with the target protein is evaluated. In the quadratic evaluation process, for a huge number of fragment placement candidate groups, collisions and cooperation are evaluated for all pairs of fragment placement candidates.

In the linear evaluation process, the fragment interaction evaluation unit 12 calculates an evaluation value for the binding of each fragment placement candidate to the target protein based on the fragment docking score for each fragment placement candidate. The evaluation value calculated by the linear evaluation process is referred to as a linear evaluation value.

In an example of the present embodiment, the fragment interaction evaluation unit 12 calculates a linear evaluation value for the binding of each fragment placement candidate to the target protein based on the size of the fragment corresponding to the fragment placement candidate, the number of fragment placement candidates for each sub-region in the binding site of the target protein, and the fragment docking score for the fragment placement candidate. Here, for example, the value indicating the fragment size is calculated based on one or more of the number of heavy atoms, the spatial size, or the like.

As an example, the fragment interaction evaluation unit 12 calculates a linear evaluation value by dividing the fragment docking score obtained by the fragment docking calculation unit 11 by a value indicating the fragment size. The linear evaluation value corresponds to the contribution to the fragment docking score per fragment size. As another example, the fragment interaction evaluation unit 12 may calculate a linear evaluation value by adding a value corresponding to the contribution to the fragment docking score per fragment size to the original fragment docking score. As another example, the fragment interaction evaluation unit 12 may calculate a linear evaluation value by adding a value corresponding to the rarity at a location where other fragments cannot be placed to the fragment docking score, depending on the number of fragment placement candidates for each sub-region in the binding site of the target protein.

Calculating a linear evaluation value based on the value corresponding to the contribution to the fragment docking score per fragment size can be said to be close to the concept of “ligand efficiency” considered for the entire compound in the field of drug discovery. In the concept of “ligand efficiency,” if a large contribution is obtained with small fragments, the remaining volume where the fragments are not placed can be used to further improve the binding affinity.

On the other hand, rewards may be provided to larger fragments so that the larger fragments are favored. For example, a value obtained by adding points to the fragment docking score of the larger fragments may be used as the linear evaluation value. This is based on the idea that, rather than being filled with fragmentary small fragments, using larger fused rings or the like as fragments results in a more compound-like structure. Here, in the linear evaluation process, the value of the fragment docking score obtained by the fragment docking calculation unit 11 may be used as a linear evaluation value without change.

In this manner, in the linear evaluation process, reflecting various pieces of knowledge in drug discovery, it is possible to adjust the evaluation of the superiority or inferiority of each fragment placement candidate. In order to reduce the calculation load in the quadratic evaluation process and subsequent processes, fragment placement candidates whose linear evaluation value is equal to or smaller than a predetermined value may be excluded in the linear evaluation process. In this case, a predetermined number of fragment placement candidates may be retained for each region within the binding site described above so that spatial diversity is secured.

In the quadratic evaluation process, the fragment interaction evaluation unit 12 calculates an evaluation value for a collision between fragment placement candidates and an evaluation value for cooperation between fragment placement candidates. In the quadratic evaluation process, the fragment interaction evaluation unit 12 calculates, for all fragment placement candidates that are not excluded in the linear evaluation process, evaluation values for collision and cooperation for all pair of fragment placement candidates. That is, in the quadratic evaluation process, evaluation is performed for both deduction in the case of collision between fragment placement candidates and addition in the case of cooperation between fragment placement candidates. The evaluation value for the collision calculated in the quadratic evaluation process is referred to as a collision evaluation value. The evaluation value for the cooperation calculated in the quadratic evaluation process is referred to as a cooperation evaluation value.

For the evaluation of collision, known methods for determining collisions between chemical substructures can be used. However, in this case, as described above, the rotation and translation of candidate placements are represented more coarsely than in known methods for determining collisions (that is, the amount of change in parameters specifying rotation and translation is adjusted to be equal to or larger than a predetermined amount so that the number of fragment placement candidates does not become too large). Accordingly, in the evaluation of collisions in the present embodiment, it is preferable to determine collisions under relaxed conditions compared to known methods for determining collisions. For example, a certain degree of collision may be permitted. As another example, even if there appears to be no collision, if there is a possibility of collision occurring when the orientation or position of the fragment placement candidate is shifted slightly, a penalty equal to or less than a predetermined amount may be applied to the collision evaluation.

Regarding the evaluation of cooperation, the cooperation evaluation value is calculated as follows. For the two paired fragment placement candidates, when the above covalent bond points (attachment points) are at close positions where a covalent bond can be formed and the covalent bond points are at an angle where a covalent bond can be formed, the two paired fragment placement candidates may be connected to each other by forming a covalent bond. Accordingly, a point is added to the cooperation evaluation value for the pair. In this case, in order to avoid excessive sensitivity to errors in placement, the determination of whether a covalent bond is formed may be performed under relaxed conditions.

Here, in the quadratic evaluation process, if the distance between the two paired fragment placement candidates is sufficiently large, the above detailed evaluation of collision and cooperation may not be performed, and the relation between the two paired fragment placement candidates may be evaluated as 0. For example, the collision evaluation value and the cooperation evaluation value may each be set to 0. In the case of the quantum annealer to be described below, since the evaluation values (a collision evaluation value and a cooperation evaluation value) obtained through the quadratic evaluation process are implemented as relationships between binary variables, evaluating ineffective and weak relations for a pair as 0 has an advantage of reducing the computational cost.

The evaluation function generation unit 13 generates an evaluation function based on the evaluation value calculated by the fragment interaction evaluation unit 12. The evaluation function is a function of giving an evaluation value for a fragment pose set of fragments constituting a compound on the surface of the target protein. In the present embodiment, the evaluation function generated by the evaluation function generation unit 13 is a Hamiltonian, which is a function that simulates the energy of a system, indicating that the lower its value, the better the solution. The Hamiltonian can be designed to correspond to, for example, a quadratic unconstrained binary optimization (QUBO) problem, which is a type of mathematical optimization problem, and can be uniquely represented by a QUBO matrix in this case. The evaluation function generation unit 13 generates a QUBO matrix that represents the Hamiltonian, and the generated QUBO matrix is input to the combinatorial optimization calculation processing unit 14.

In the present embodiment, for example, fragment-based compound docking calculation in consideration of the internal degrees of freedom of the compound is formulated and executed as a QUBO problem. As a method of modeling the evaluation values (linear evaluation values, collision evaluation values, and cooperation evaluation values) obtained by the fragment interaction evaluation unit 12 as a QUBO problem, any methods may be used. As an example, fragment placement candidates (fragment placement candidates that remain without being excluded in the linear evaluation process and the quadratic evaluation process) that are favorable (with favorable fragment docking scores) in the fragment docking calculation results of the fragments are used as candidates, and using binary variables indicating whether these fragment placement candidates are used, the linear evaluation values can be used for the linear terms of the QUBO problem, and the quadratic evaluation values (collision evaluation values and cooperation evaluation values) can be used for the quadratic terms of the QUBO problem. The linear terms and the quadratic terms of the QUBO problem are collectively represented as a QUBO matrix.

An example of a specific configuration in the present embodiment is shown below.

The following elements are considered when the fragment-based compound docking calculation is formulated as a QUBO problem.
(a) A compound is represented as a plurality of fragments;
(b) poses resulting from independent docking of the fragments are used as candidate;
(c) for each fragment, only one pose is selected from the set of possible poses;
(d) collisions between fragments are considered; and
(e) for covalently bonded fragments, the covalent bond distances between poses are considered.

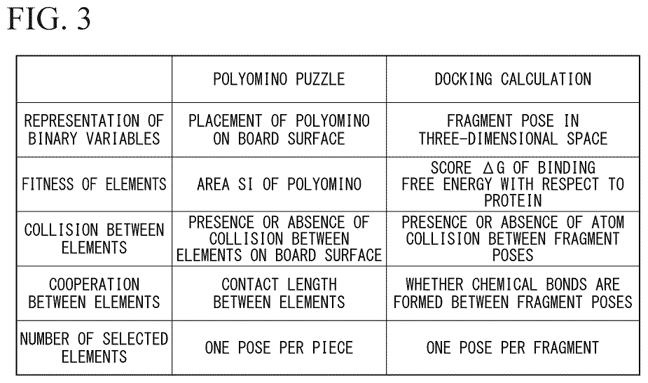

These elements are similar to the components of the Hamiltonian when the protein-compound docking calculation is approximated as a generalized polyomino puzzle (refer to Non-Patent Document 5). Although the polyomino puzzle itself is merely a geometric puzzle, it has properties very similar to the protein-compound docking calculation, and it will be referred to for illustrative purposes below. FIG. 3 shows a comparison between the polyomino puzzle and the fragment-based compound docking calculation.

In combinatorial optimization, binary variables taking a value of 0 or 1 serve as explanatory variables for the problem (spins taking a value of −1 or 1 may also be used). The setting of binary variables for the problem is an important point because the difficulty of the combinatorial optimization problem can change significantly depending on the selection. As described above, in the present embodiment, the problem is formulated by treating each fragment placement candidate in the three-dimensional space as one binary variable.

Since an infinite number of fragment placement candidates can be enumerated in the three-dimensional space, it is necessary to limit the number based on some conditions. The simplest condition is to select fragment placement candidates with favorable fitness of elements (fragment docking scores for the target protein and each fragment placement candidate). However, it has been pointed out that, among the group of fragment placement candidates constituting the compound structure in the complex three-dimensional structure of the protein and compound, there are fragments that do not themselves exhibit favorable binding free energy with the target protein, but serve as linkers connecting fragment placements with favorable binding free energy. Thus it is necessary to select fragment placement candidates to be treated as binary variables not only based on favorable fragment docking scores but also in consideration of securing diversity in their positions.

The fitness of an element is the local gain obtained by selecting the corresponding fragment placement candidate (setting the binary variable to a value of 1). In the fragment-based compound docking calculation, the compound docking score is expressed as the sum of the fragment docking scores of the selected fragment placement candidates. Since the sum of the fragment docking scores of the fragment placement candidates corresponding to each binary variable can be expressed as a linear term, if each fragment placement candidate is i, the fragment docking score of this placement candidate with respect to the target protein is ΔGᵢ, and the binary variable corresponding to i is xᵢ, the binding free energy score of the compound can be expressed as shown in Formula (1).

$${H}_{1} = {\sum }_{i} Δ {G}_{i} {x}_{i} \qquad ( 1 )$$

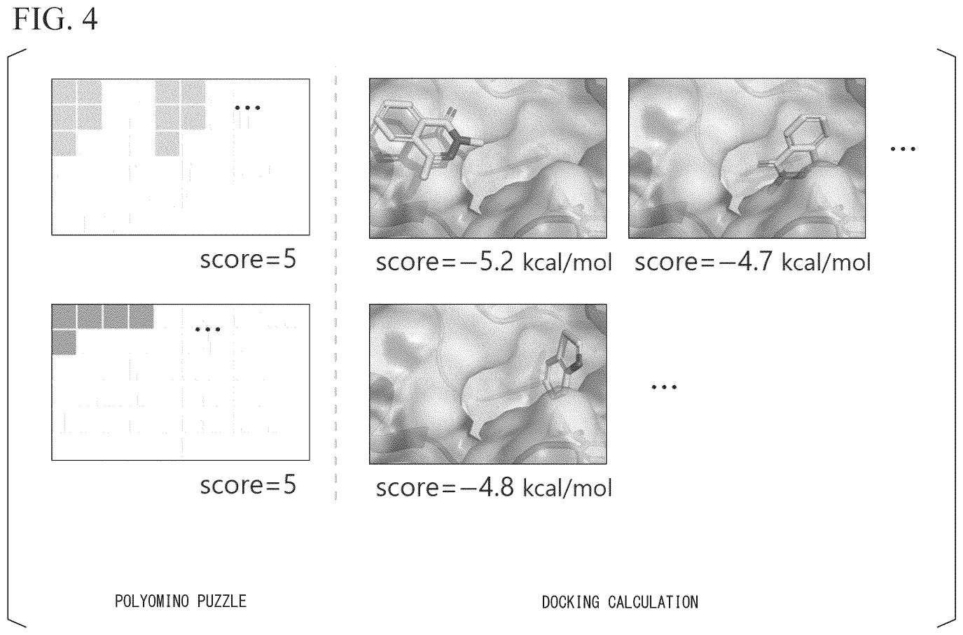

FIG. 4 shows a comparison between a polyomino puzzle and a fragment-based compound docking calculation in terms of representation of binary variables, fitness of elements, collisions between elements, cooperation between elements, and the number of selected elements.

Regarding the collisions between elements, for example, in the case of the polyomino puzzle, polyominos should not overlap each other. Similarly, a state in which fragment placement candidates that collide with each other are selected simultaneously is inappropriate for the compound structure, and a penalty should be applied to such a collision. Accordingly the penalty for collision is expressed as shown in Formula (2) using the function clash(i, j). The range of values that the function clash(i, j) can take is a real number of 0 or more.

$${H}_{2} = {\sum }_{i , j} clash ( i , j ) {x}_{i} {x}_{j} \qquad ( 2 )$$

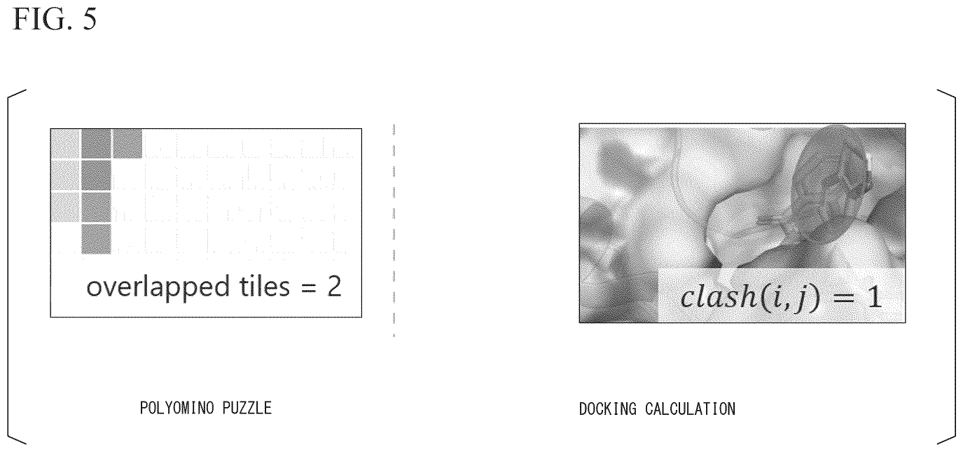

FIG. 5 shows a comparison between a polyomino puzzle and a fragment-based compound docking calculation in terms of collisions between elements.

On the other hand, in contrast to the collisions between elements described above, the cooperation between elements is expressed as shown in Formula (3) using the function conn(i, j). The range of values that the function conn(i, j) can take is a real number of 0 or less.

$${H}_{3} = {\sum }_{i , j} conn ( i , j ) {x}_{i} {x}_{j} \qquad ( 3 )$$

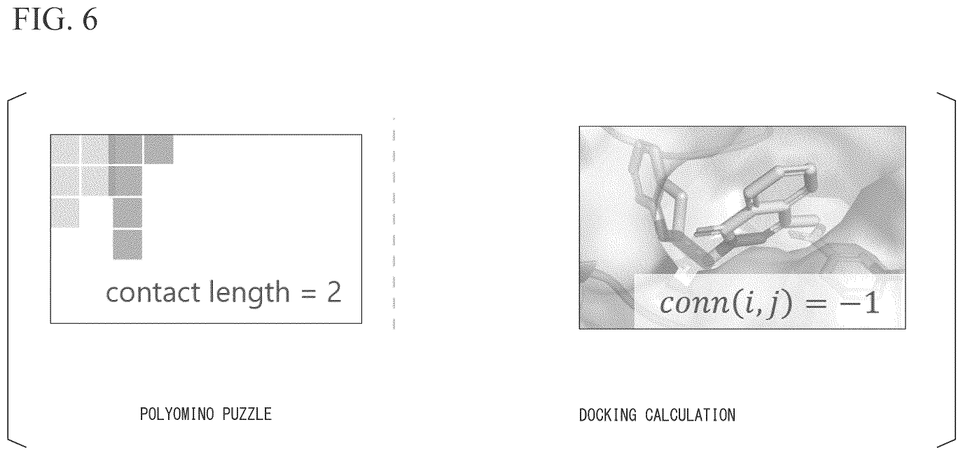

FIG. 6 shows a comparison between a polyomino puzzle and a fragment-based compound docking calculation in terms of cooperation between elements.

The number of selected elements will be described. Compound docking calculation is to estimate a binding mode between a certain target protein and a compound included in the compound data 20. For example, a compound is composed of three fragments (fragment a, fragment b, and fragment c). In this case, even if there are two or more fragments having the same structural formula among these three fragments, the two or more fragments are treated as separate fragments. In this case, in order to reconstruct the compound structure, only one pose of fragment a should be selected. Similarly, one pose each for the fragment b and the fragment c should be selected. Here, this is exactly the same as the condition in the polyomino puzzle that “each polyomino is used once,” and the constraint condition regarding the number of selected elements can be expressed as shown in Formula (4). Here, F is the set of fragments constituting the compound, and fᵢ is the fragment corresponding to the fragment placement candidate i.

$${H}_{4} = \frac{1}{2} {\sum }_{k}^{F} {( {\sum }_{{f}_{i} = k} {x}_{i} - 1 )}^{2} + \frac{1}{2} {\sum }_{k}^{F} {\sum }_{{f}_{i} = k} {x}_{i} ( 1 - {x}_{i} ) \qquad ( 4 )$$

Using the four terms represented by the above Formula (1) to Formula (4), the Hamiltonian H, which is the objective function to be minimized, is designed as follows.

$$H = {AH}_{1} + {BH}_{2} + {CH}_{3} + {DH}_{4} \qquad ( 5 )$$

Here, a coefficient A, a coefficient B, a coefficient C, and a coefficient D are weight parameters for the terms. The coefficient A, the coefficient B, the coefficient C, and the coefficient D are each a real number of 0 or more. In an example of the present embodiment, for the coefficients (weight parameters) for the terms, a value of 1 is first set as the coefficient A, a preliminary experiment is then performed, and for the remaining coefficients, a value of 5 is set as the coefficient B, a value of 5 is set as the coefficient C, and a value of 25 is set as the coefficient D.

The evaluation function generation unit 13 generates a QUBO matrix that represents the Hamiltonian H shown in Formula (5). The evaluation function generation unit 13 outputs the generated QUBO matrix in a predetermined format. The predetermined format refers to, for example, a Matrix Market (MM) format, which is a standard format used for matrix representation, or a Hierarchical Data Format 5 (HDF5) in which data is represented in binary form.

The combinatorial optimization calculation processing unit 14 calculates a fragment pose set of fragments constituting a compound on the surface of the target protein by determining, based on combinatorial optimization, a state that optimizes the evaluation function generated by the evaluation function generation unit 13. In an example of the present embodiment, the combinatorial optimization calculation processing unit 14 calculates the fragment pose set by determining a state that minimizes the Hamiltonian H based on combinatorial optimization using the QUBO matrix. The combinatorial optimization calculation processing unit 14 inputs the QUBO matrix generated by the evaluation function generation unit 13 to, for example, a quasi-quantum annealer, and obtains a solution (local optimum solution) to the QUBO problem that minimizes the Hamiltonian H. The local optimum solution is expected to represent a solution of, among various fragment placement candidates represented as binary variables, those that exhibit a favorable fragment docking score with the target protein, do not collide with each other, and can appropriately form covalent bonds therebetween. Here, in the combinatorial optimization calculation processing unit 14, another method in which a solution to the QUBO problem can be obtained using a quantum annealer or simulated annealing instead of a quasi-quantum annealer may be used.

As a quasi-quantum annealer, a quantum-inspired optimization solution SQBM+ (commercially available from Toshiba Digital Solutions Corporation) can be used. SQBM+ is a quantum-inspired optimization solution centered on the combinatorial optimization solver Simulated Bifurcation Machine (SBM) using Simulated Bifurcation (SB) algorithm. In SQBM+, a large number of diverse local optimum solutions can be obtained in a single calculation by using a unique SB algorithm. Here, other solutions may be used as the quasi-quantum annealer.

The post-processing unit 15 performs post-processing on the fragment pose set calculated by the combinatorial optimization calculation processing unit 14. As a result of the post-processing, the post-processing unit 15 outputs a small number of effective solutions from among diverse local optimum solutions.

For example, the post-processing unit 15 verifies the local optimum solution obtained by the quasi-quantum annealer. In the Hamiltonian H shown in the above Formula (5), the fourth term H₄ represents a so-called one-hot constraint for realizing the condition that a single fragment is placed in exactly one location. That is, the Hamiltonian H includes a constraint condition indicating that each fragment is selected once as a fragment placement candidate. Although this constraint condition should be satisfied, among diverse local optimum solutions, there may be unacceptable solutions in which a single fragment is placed in two locations. The post-processing unit 15 removes such unacceptable solutions.

Here, the post-processing unit 15 may analyze not only the Hamiltonian H value for the local optimum solution obtained by the quasi-quantum annealer but also the degree of contribution of the terms constituting the Hamiltonian H, and present the results to a user.

The local structure optimization unit 16 forms covalent bonds for bonding fragments together for each effective solution indicated by the post-processing result, and constructs a structure that can be interpreted as one compound molecule. In addition, the local structure optimization unit 16 performs local structure optimization processing on the molecular structure. The local structure optimization unit 16 removes molecular structural distortions based on, for example, an energy minimization method. Here, the energy minimization method is known, and is a standard method used to remove structural distortions in compound modeling and the like.

The output unit 17 outputs the docking calculation result obtained by the local structure optimization unit 16 performing local structure optimization processing. As an example, the output unit 17 outputs only one binding pose with the best evaluation score as the docking calculation result. Here, the output unit 17 may output, as the docking calculation results, a predetermined number of binding pose candidates in descending order of evaluation scores while taking diversity into consideration.

The output unit 17 outputs the docking calculation results. For example, the output unit 17 outputs the docking calculation results to an external device (a server, a display device, etc.) separate from the calculation processing device 1. The output unit 17 may store the docking calculation results in the storage unit 2 as a database.

According to the above procedure, in the calculation processing device 1 according to the present embodiment, compound docking calculation results (one or multiple binding poses and evaluation scores) can be obtained by combinatorial optimization using the quasi-quantum annealer from the fragment docking calculation results performed for each fragment for a specific input compound.

Here, calculation may be repeated based on the degree of contribution of the terms constituting the Hamiltonian H analyzed in the post-processing unit 15 or the final docking calculation result. The determination of whether calculation is repeated may be made by the user or automatically determined by the calculation processing device 1. For example, calculation can be repeated while slightly changing the weight parameters of the terms constituting the Hamiltonian H. When only the weight parameters are changed, among the above processes, the process performed by the evaluation function generation unit 13 to the process performed by the output unit 17 may be repeated.

In addition, in the post-processing performed by the post-processing unit 15, if a trend in which there is a noticeable collision between fragment placement candidates and in the formation of covalent bonds by the local structure optimization unit 16, there are many solution candidates in which the angle of the covalent bond is unnatural is detected, it is possible to return the process to the process performed by the fragment interaction evaluation unit 12 and adjust the threshold value for determining regarding the penalty for collision or the reward for cooperation. The adjustment of these threshold values can be incorporated into an automatic function in many cases by acquiring data while repeating the compound docking calculation.

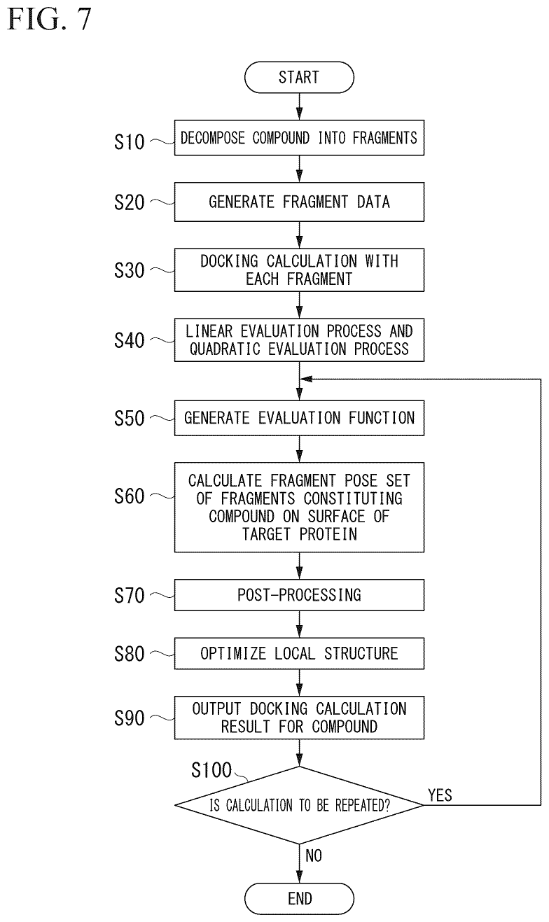

FIG. 7 is a diagram showing an example of a flow of a fragment-based compound docking calculation process according to the present embodiment.

Step S10: The fragment decomposition unit 10 decomposes a compound into fragments. As an example, the fragment decomposition unit 10 reads data of a compound designated by the user from the compound data 20 stored in the storage unit 2. Here, the calculation processing device 1 includes an operation unit (not shown in FIG. 1) configured to receive an operation from the user. The fragment decomposition unit 10 decomposes the compound into fragments based on the read compound data.

Step S20: In addition, the fragment decomposition unit 10 generates fragment data based on the decomposition processing result.

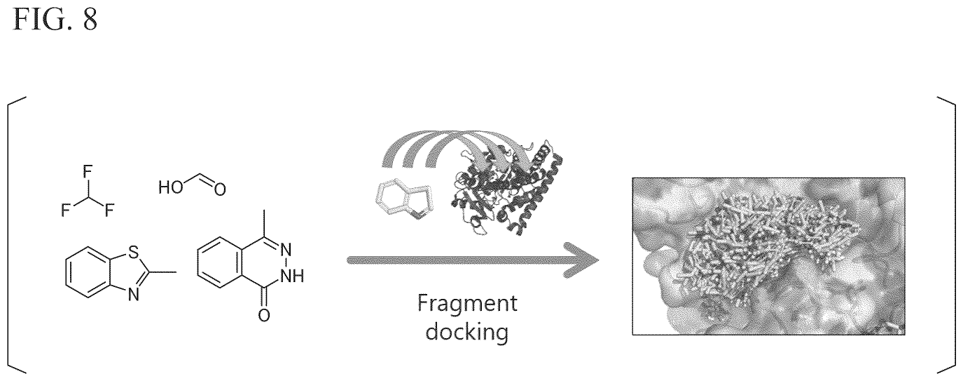

Step S30: The fragment docking calculation unit 11 executes for each fragment indicated by the fragment data, fragment docking calculation between the fragment and the target protein. The fragment docking calculation unit 11 calculates the fragment docking calculation results (fragment placement candidates and their fragment docking scores). FIG. 8 shows how the fragment docking calculation results are obtained from the fragment data by the docking calculation.

As described above, the fragment placement candidate group to be subjected to combinatorial optimization should be composed of placement candidates with favorable binding free energy while maintaining diversity, and such candidates should be efficiently retained. Accordingly, the compound is decomposed into fragments, the binding site of the target protein is then divided into many 2 Å×2 Å×2 Å sub-regions, docking calculations between the target protein and the fragment are performed independently for all sub-regions, and for each sub-region, a maximum of 20 poses are output as fragment placement candidates per fragment.

In the docking calculation performed by the fragment docking calculation unit 11, a known docking calculation algorithm is used, and in order to secure the structure diversity, local optimization is not performed, and only fragment placement candidates with a negative binding free energy score (considered to be good solution candidates) are output. In addition, in order to make the fragment placement candidates non-redundant, the root-mean-square deviation (RMSD) of atomic positions is set to at least 1.0 Å apart. Here, the RMSD between fragment placement candidates output from above-mentioned sub-regions may be less than 1.0 Å. Accordingly, if there is a pair of fragment placement candidates for which the RMSD is less than 1.0 Å again after the fragment docking calculation results of the sub-regions are aggregated, only fragment placement candidates with favorable fragment docking scores are retained.

Step S40: The fragment interaction evaluation unit 12 performs the linear evaluation process and the quadratic evaluation process.

In the linear evaluation process, the fragment interaction evaluation unit 12 calculates a linear evaluation value for the binding of each fragment placement candidate to the target protein based on the fragment docking score for each fragment placement candidate. The fragment interaction evaluation unit 12 excludes fragment placement candidates whose linear evaluation value is worse than a predetermined threshold value.

The fragment interaction evaluation unit 12 performs the quadratic evaluation process on the fragment placement candidates that are not excluded in the linear evaluation process. In the quadratic evaluation process, the fragment interaction evaluation unit 12 calculates a collision evaluation value for a collision between fragment placement candidates and a cooperation evaluation value for cooperation between fragment placement candidates. The collision evaluation value is used as a function clash(i, j) indicating a collision included in the second term H₂ of the Hamiltonian H shown in Formula (5). The cooperation evaluation value is used as a function conn(i, j) indicating a covalent bond between fragments included in the third term H₃ of the Hamiltonian H.

The function clash(i, j) and the function conn(i, j) are each expressed using physicochemical parameters. The physicochemical parameters are, for example, the bond length, bond angle, and dihedral angle of the covalent bond, and the interatomic distance between atoms. The molecular mechanical force field calculates the interaction energy from the values of these physicochemical parameters, and it is desirable to use the interaction energy calculated by the molecular mechanical force field. However, the number of fragment placement candidates that can be considered in combinatorial optimization is limited, and combinations of fragment placement candidates that exhibit appropriate bond lengths and bond angles particularly for covalent bonds are not always obtained. Accordingly, after the energy score is calculated using the molecular mechanical force field, candidates are deemed bondable if the distortion energy or intermolecular collision energy is equal to or less than a predetermined value.

The fragment interaction evaluation unit 12 calculates an interaction energy ENB(i, j) for the fragment placement candidate i and the fragment placement candidate j when no covalent bond is formed between the fragment placement candidate i and the fragment placement candidate j.

When a covalent bond is formed between the fragment placement candidate i and the fragment placement candidate j, the fragment interaction evaluation unit 12 calculates an interaction energy EB (i, j) when a covalent bond is formed.

The fragment interaction evaluation unit 12 sets conn(i, j)=−1 if the fragment fᵢ and the fragment fⱼ corresponding to the fragment placement candidate i and the fragment placement candidate j, respectively, are connected by a covalent bond in the original compound, and EB (i, j)≤_{E}. The fragment interaction evaluation unit 12 sets conn(i, j)=0 if the fragment fᵢ and the fragment fⱼ are connected by a covalent bond in the original compound, and EB (i, j)>th_{E}. Here, the energy score threshold value the is a predetermined threshold value.

The fragment interaction evaluation unit 12 sets clash(i, j)=1 if conn(i, j)=0 and ENB(i, j)>th_{E}. The fragment interaction evaluation unit 12 sets clash(i, j)=0 if conn(i, j)/0 or ENB(i, j)≤th_{E}.

The energy score is calculated using RDKit (version 2023.09.5) based on Universal Force Field (UFF). In addition, in order to sufficiently allow structural distortions, the energy score threshold value the is set to 500 kcal/mol.

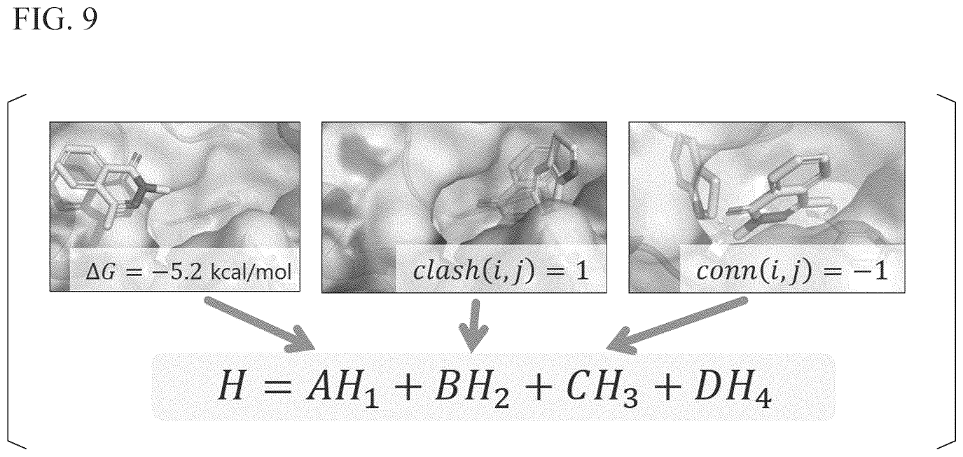

Step S50: The evaluation function generation unit 13 generates a Hamiltonian H based on the evaluation value calculated by the fragment interaction evaluation unit 12. As described above, the evaluation function generation unit 13 generates a Hamiltonian H by generating a QUBO matrix. FIG. 9 shows how the Hamiltonian H is generated. The linear evaluation value is used as ΔGᵢ, which is a fragment docking score included in the first term H₁. The collision evaluation value is used as a function clash(i, j), indicating a collision, included in the second term H₂. The cooperation evaluation value is used as a function conn(i, j), indicating a covalent bond between fragments, included in the third term H₃.

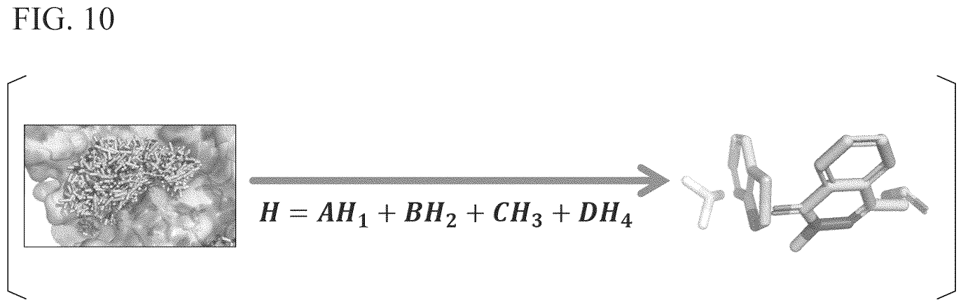

Step S60: The combinatorial optimization calculation processing unit 14 calculates a fragment pose set of fragments constituting a compound on the surface of the target protein by determining, based on combinatorial optimization, a state that optimizes the evaluation function generated by the evaluation function generation unit 13. The combinatorial optimization calculation processing unit 14 inputs the QUBO matrix generated by the evaluation function generation unit 13 to a quasi-quantum annealer to obtain a solution to the QUBO problem that minimizes the Hamiltonian H. In the present embodiment, when SQBM+ is used as the quasi-quantum annealer, many local optimum solutions to the QUBO problem are obtained. More specifically, using SQBM+ for AWS (version 2. 0. 1), calculation is performed for 300 seconds (timeout=300) when the QUBO matrix is input with the single-precision floating-point number accuracy, and many outputs are acquired. FIG. 10 shows how a solution to the QUBO problem is obtained by combinatorial optimization using the quasi-quantum annealer. FIG. 10 shows one of many local optimum solutions obtained by SQBM+ from many fragment placement candidate groups.

Step S70: The post-processing unit 15 performs post-processing on the fragment pose set calculated by the combinatorial optimization calculation processing unit 14. The local optimum solutions output from SQBM+ may include solutions in which two or more fragment placement candidates are selected for one fragment. In order to output a structure that can be interpreted as one compound molecule, one fragment placement candidate should be selected for one fragment. Accordingly, in the post-processing, from among the obtained plurality of local optimum solutions, only solutions in which all fragments constituting the compound are selected one by one are selected.

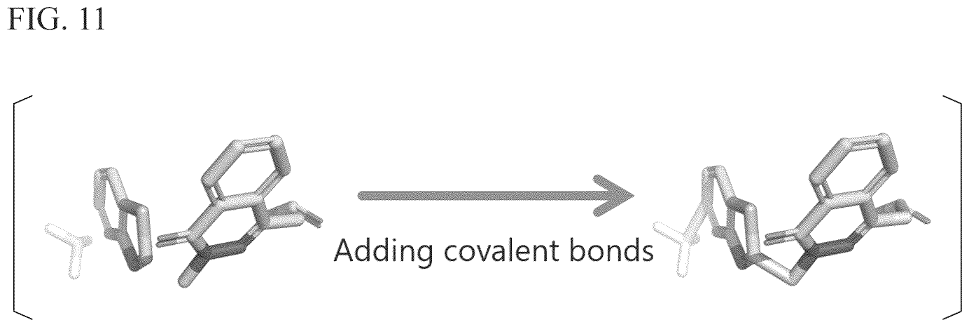

Step S80: The local structure optimization unit 16 forms covalent bonds for bonding fragments together for the solutions selected by the post-processing unit 15 and outputs each of the obtained solution candidates as a structure that can be interpreted as one compound molecule. FIG. 11 shows how covalent bonds are formed between the fragments.

In addition, the local structure optimization unit 16 performs local structure optimization processing on a molecular structure that can be interpreted as one compound molecule obtained by forming covalent bonds.

Step S90: The output unit 17 outputs the docking calculation result for the compound. The output unit 17 outputs, for example, the result to an external device (a server, a display device, etc.) separate from the calculation processing device 1.

Step S100: The calculation processing device 1 determines whether or not to repeat calculation. For example, the calculation processing device 1 determines to repeat the calculation when it receives, from the user, an operation indicating that the calculation should be repeated. The user checks the final docking calculation result displayed on the display device or the result of the degree of contribution analyzed by the post-processing unit 15, and determines whether or not to repeat calculation. The result of the degree of contribution analyzed by the post-processing unit 15 is the analysis result of the degree of contribution of the terms constituting the Hamiltonian H. As another example, the calculation processing device 1 may automatically determine whether or not to repeat calculation based on the final docking calculation result or the result of the degree of contribution analyzed by the post-processing unit 15.

When the calculation processing device 1 determines to repeat the calculation (Step S100; YES), it executes the processes from Step S50 to Step S90 again. On the other hand, when the calculation processing device 1 determines not to repeat the calculation (Step S100; NO), it ends the process.

This concludes the description of the flow of the fragment-based compound docking calculation process according to the present embodiment.

Next, an example of fragment-based compound docking using the calculation processing device 1 according to the present embodiment will be described.

First, in order to evaluate the performance of the calculation processing device 1, a re-docking experiment is performed. In the re-docking experiment, for proteins and ligands whose three-dimensional structures during binding are experimentally known, only the ligand structure is extracted, the three-dimensional structures of the protein and the ligand during binding are estimated again by the docking calculation, and thus the performance of the calculation processing device 1 is evaluated. In the performance evaluation, if the distance between the experimentally known binding structure and the binding structure obtained by the docking calculation is a predetermined distance (for example, 2.5 Å in RMSD) or less, the three-dimensional structure is considered to be correctly estimated.

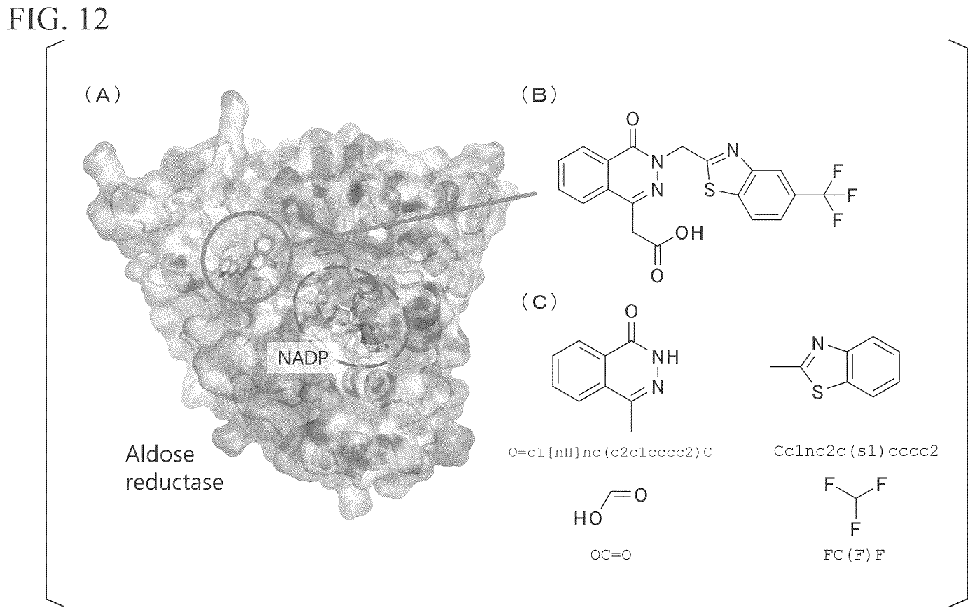

In the re-docking experiment, aldose reductase (ALDR) is used. As shown in FIG. 12(A), ALDR is known as an enzyme which is composed of about 300 amino acid residues, and causes reactions such as a reaction in which glucose is reduced to sorbitol using Nicotinamide Adenine Dinucleotide Phosphate (NADP). The ALDR is an enzyme that is thought to be related to neuropathy in diabetes and is one of the target proteins in drug discovery, as exemplified by an approved drug called epalrestat that inhibits this protein.

First, a co-crystal structure (PDB ID: 2HV5) of ALDR with a known inhibitor is acquired from Protein Data Bank (PDB). FIG. 12(B) shows the molecular structure of the inhibitor. Based on the compound decomposition algorithm described in Non-Patent Document 3, inhibitor molecules are decomposed into fragments. As a result of fragment decomposition, inhibitor molecules are decomposed into four fragments as shown in FIG. 12(C). The ionization state and three-dimensional structure of the fragments are estimated using LigPrep (commercially available from Schrodinger).

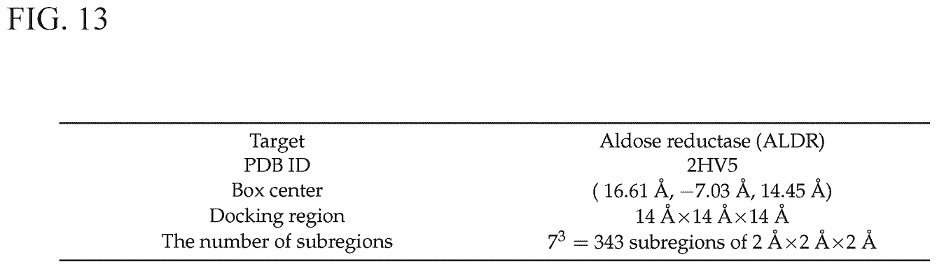

Next, the binding site for performing fragment docking calculation on each fragment is determined using the docking calculation parameter as shown in FIG. 13. The box center is the center of the three-dimensional structure of a co-crystal inhibitor, and the docking region is determined visually as the size of a cube covering the entire inhibitor three-dimensional structure.

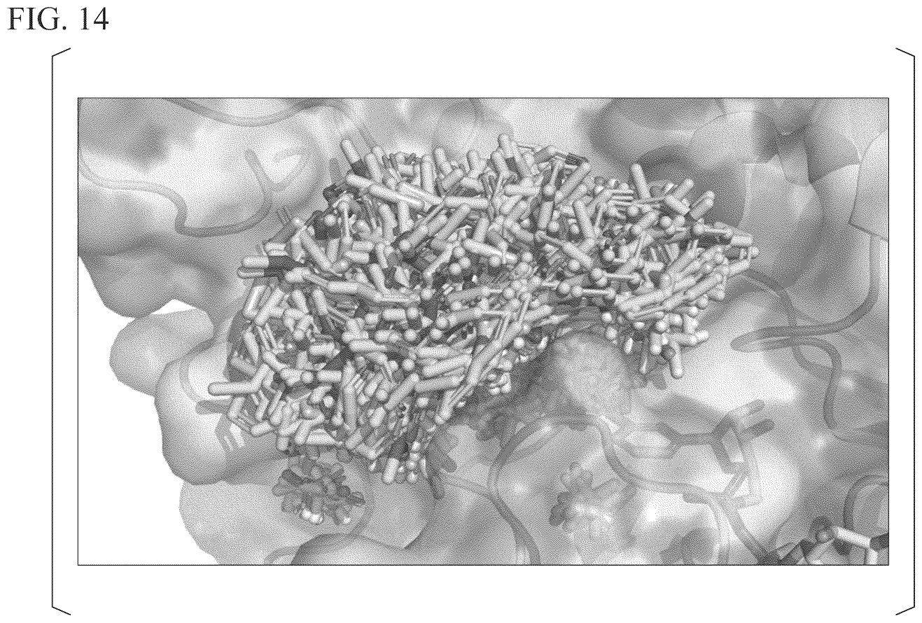

Next, FIG. 14 shows the results of fragment docking calculation using each fragment. The number of fragment placement candidates obtained by fragment docking calculation using each fragment is 3,005. FIG. 14 shows all of these 3,005 fragment placement candidates. When the binding site is divided into many sub-regions, the fragment placement candidates are distributed across the entire binding site of the target protein.

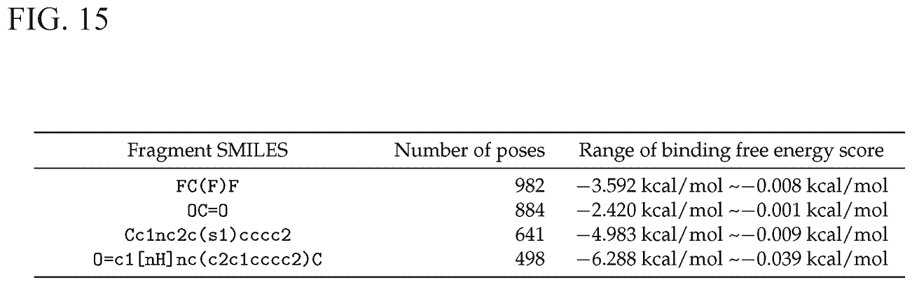

The number of fragment placement candidates obtained for each fragment and the maximum value and the minimum value of these fragment docking scores are shown in the table in FIG. 15. Here, in FIG. 15, the structural formula of each fragment is represented by a Simplified Molecular Input Line Entry System (SMILES).

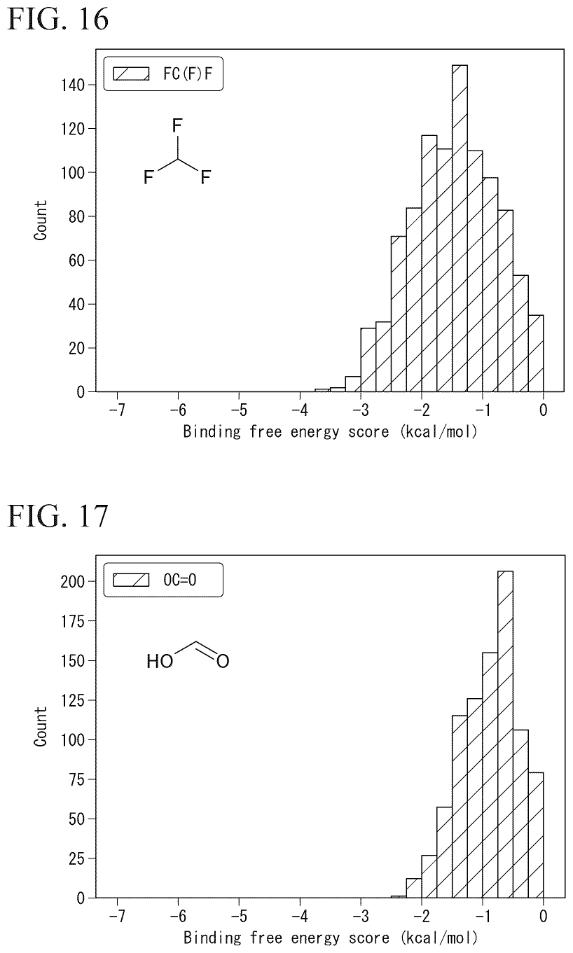

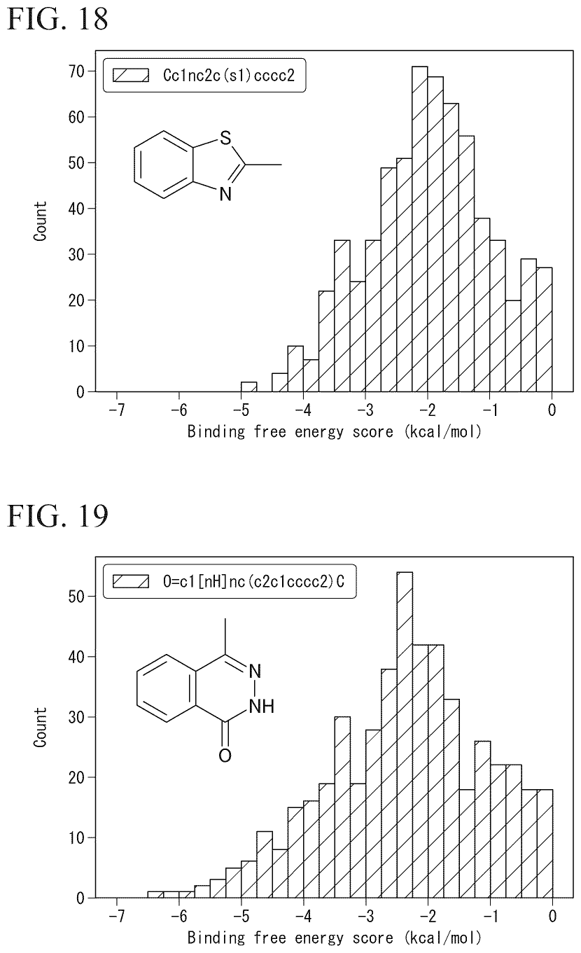

In addition, FIG. 16 to FIG. 19 show the distributions of the fragment docking scores for the fragments. It is noteworthy that, in addition to poses with favorable fragment docking scores, poses with less favorable fragment docking scores are also retained as fragment placement candidates. When fragment placement candidates with favorable scores are obtained for each sub-region, it is possible to acquire fragment placement candidates that can function as linkers even in regions with limited direct interactions with the protein. Therefore the obtained fragment placement candidate group suggests that positional diversity can be secured.

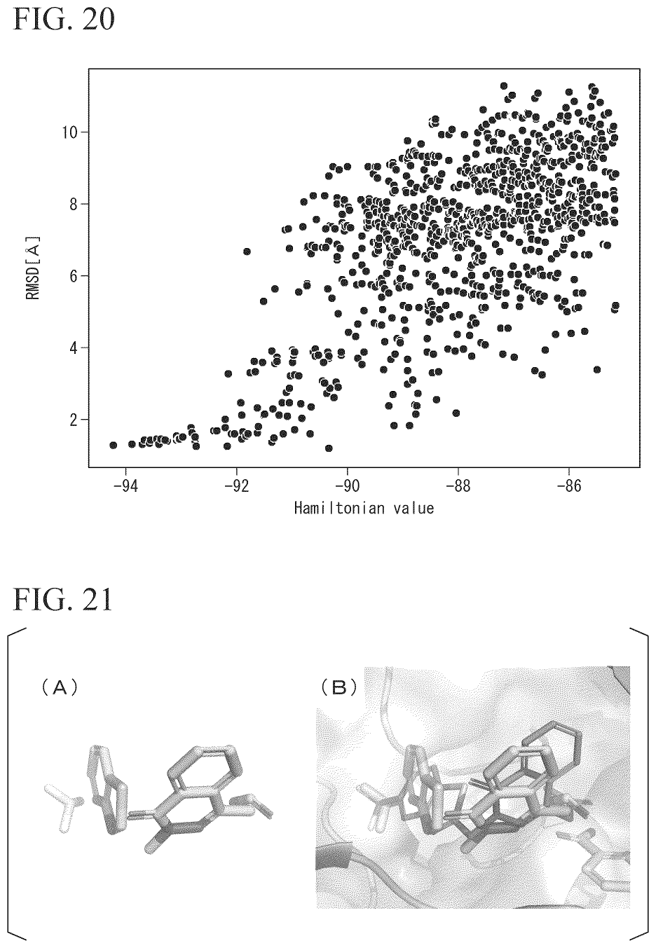

As a result of combinatorial optimization calculation using SQBM+, 7,298 local optimum solutions are obtained. First, among the obtained local optimum solutions, 5,414 (74.2%) solutions in which all fragments are used once are extracted. Among these solutions, for the top 1,000 solutions with favorable Hamiltonian H values (combinatorial energy), the Hamiltonian values after combinatorial optimization calculation are performed and RMSDs relative to the correct structure of the docking calculation results are scatter-plotted in FIG. 20. It can be understood that, regarding the distribution of higher-ranking solutions among these 1,000 solutions, a funnel shape in which the RMSD is lower as the Hamiltonian value is better can be confirmed, and the Hamiltonian H is appropriately designed.

Next, FIG. 21 shows the fragment pose set as the best solution among the obtained local optimum solutions. According to the fragment pose set shown in FIG. 21(A), it can be understood that, in this best solution, the fragments are positioned in close proximity to each other, and the structure does not exhibit any significant inconsistencies as one compound structure. In addition, FIG. 21(B) shows the results in which the fragment pose set as the best solution, the co-crystal structure and the three-dimensional protein structure overlap. The RMSD of this fragment pose set relative to the correct structure of docking is 1.26 Å, confirming that the binding pose can be sufficiently estimated.

Since the fragment pose set itself shown in FIG. 21(A) has structural distortions, it is inappropriate to directly use the fragment pose set as the docking calculation result. Therefore the molecular structural distortions are removed by local structure optimization. In the local structure optimization, an energy minimization method is used to optimize the distorted compound structure constructed from the fragment pose set within the three-dimensional protein structure, which is treated as a rigid body. For local structure optimization, software Maestro (version 2020-2, commercially available from Schrodinger) is used.

The predicted complex structure obtained by overlapping the three-dimensional structure (PDB ID: 2HV5) of the target protein ALDR and a structure that can be interpreted as a compound molecule obtained by combinatorial optimization and post-processing is processed using Protein Preparation Wizard's Preprocess and H-bond assignment, the protein and the coenzyme (NADP) are treated as rigid bodies, and energy minimization of the three-dimensional structure of the compound is then executed using an OPLS3e force field.

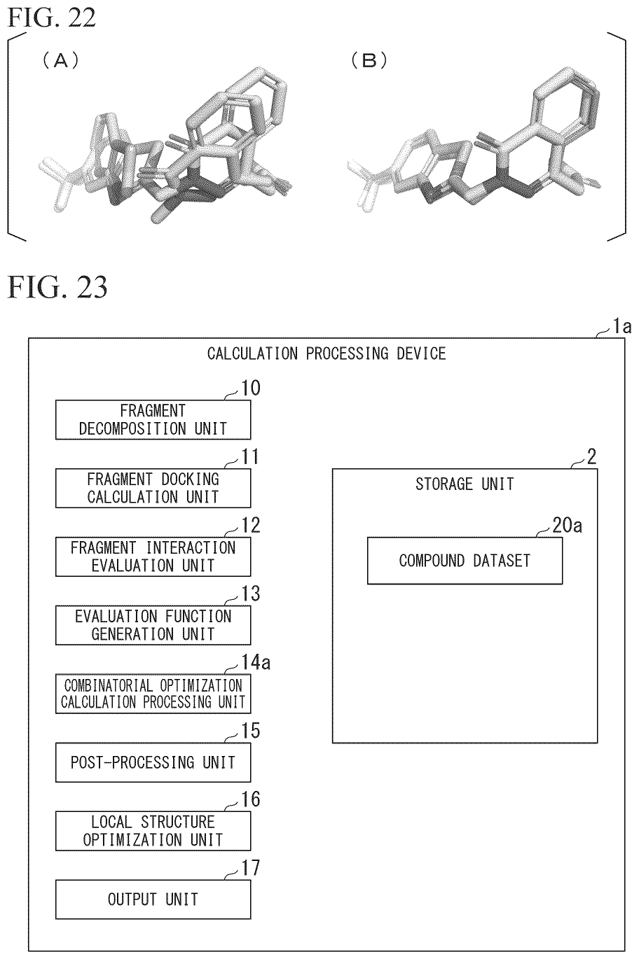

FIG. 22 shows the results of compound docking calculation after local structure optimization is performed. FIG. 22(A) shows a diagram in which the fragment pose set before local structure optimization is performed and the docking calculation result after local structure optimization is performed overlap. FIG. 22(B) shows a diagram in which the docking calculation result after local structure optimization is performed and the co-crystal structure (experimentally known binding structure) overlap. Based on the result shown in FIG. 22(B), the RMSD between the docking calculation result of the obtained compound and the co-crystal structure is 0.27 Å, and a structure almost identical to the co-crystal structure is obtained.

Here, in the present embodiment, an example in which the Hamiltonian H shown in Formula (5) is used as the Hamiltonian has been described, but the present invention is not limited thereto. Hamiltonians other than the Hamiltonian H shown in Formula (5) may be used. For example, in the Hamiltonian H, the second term H₂ or the third term H₃ among the terms shown in Formula (5) may be omitted, and the first term H₁, the second term H₂, or the third term H₃ may be modified from the above Formula (1), Formula (2), or Formula (3). In addition, the values of the weight parameters of the terms may be set to values other than the above values. However, in order to improve the estimation accuracy of the calculation based on the combinatorial optimization of the fragment-based compound docking calculation, it is preferable to use the Hamiltonian H shown in Formula (5).

Here, one or more of the post-processing unit 15, the local structure optimization unit 16, and the output unit 17 may be omitted from the configuration of the calculation processing device 1. In this case, the processes performed by the post-processing unit 15, the local structure optimization unit 16, and the output unit 17 are performed by an information processing device separate from the calculation processing device 1, the calculation processing device 1 may acquire the results of processing performed by the information processing device, and may cause the results of processing performed by the calculation processing device 1 to be output to the information processing device.

As described above, the compound docking calculation processing device according to the present embodiment (the calculation processing device 1 in the present embodiment) includes the fragment decomposition unit 10, the fragment docking calculation unit 11, the fragment interaction evaluation unit 12, the evaluation function generation unit 13, and the combinatorial optimization calculation processing unit 14.

The fragment decomposition unit 10 acquires fragment data indicating fragments, which are chemical substructures of a compound used to perform docking calculation with a target biomolecule (a target protein in the present embodiment).

The fragment docking calculation unit 11 executes, for each fragment indicated by the fragment data, fragment docking calculation between the fragment and a target biomolecule (a target protein in the present embodiment).

The fragment interaction evaluation unit 12 calculates evaluation values (linear evaluation values, collision evaluation values, and cooperation evaluation values in the present embodiment) for fragment placement candidates and the interrelationship between fragment placement candidates based on the fragment docking score for each fragment placement candidate, which is a placement candidate when a fragment binds to a target biomolecule (a target protein in the present embodiment) and the positional relationship between fragment placement candidates.

The evaluation function generation unit 13 generates an evaluation function (Hamiltonian H in the present embodiment) of giving an evaluation value for a fragment pose set of fragments constituting a compound on the surface of a target biomolecule (a target protein in the present embodiment) based on the evaluation value.

The combinatorial optimization calculation processing unit 14 calculates a fragment pose set of fragments constituting a compound on the surface of a target biomolecule (a target protein in the present embodiment) by determining a state that optimizes the evaluation function based on combinatorial optimization.

With this configuration, the calculation processing device 1 according to the present embodiment calculates evaluation values for fragment placement candidates and the interrelationship between fragment placement candidates based on the fragment docking score for each fragment placement candidate and the positional relationship between fragment placement candidates, generates an evaluation function using these evaluation values, and can calculate a fragment pose set of fragments constituting a compound on the surface of a target biomolecule (a target protein in the present embodiment) by determining a state that optimizes the evaluation function based on combinatorial optimization, and thus combinatorial optimization in fragment-based compound docking calculation can be performed. As described above, in an example of the present embodiment, an evaluation function (in the present embodiment, Hamiltonian H) corresponding to the QUBO problem is designed, for example, the QUBO matrix is input to a quasi-quantum annealer, and thus the combinatorial optimization can be efficiently performed.

### Second Embodiment

A second embodiment of the present invention will be described below in detail with reference to the drawings. The compound docking calculation processing device according to the present embodiment is referred to as a calculation processing device 1a. Here, the same components as those in the first embodiment described above are denoted with the same reference numerals and the descriptions of the same components and operations may be omitted.

FIG. 23 is a diagram showing an example of a functional configuration of the calculation processing device 1a according to the present embodiment. The calculation processing device 1a includes the fragment decomposition unit 10, the fragment docking calculation unit 11, the fragment interaction evaluation unit 12, the evaluation function generation unit 13, a combinatorial optimization calculation processing unit 14a, the post-processing unit 15, the local structure optimization unit 16, the output unit 17, and the storage unit 2. Comparing the calculation processing device 1a according to the present embodiment (FIG. 23) with the calculation processing device 1 according to the first embodiment (FIG. 1), the differences are in the combinatorial optimization calculation processing unit 14a, and the storage unit 2 storing a compound dataset 20a. Here, the functions of other components (the fragment decomposition unit 10, the fragment docking calculation unit 11, the fragment interaction evaluation unit 12, the evaluation function generation unit 13, the post-processing unit 15, the local structure optimization unit 16, and the output unit 17) are the same as those in the first embodiment. However, detailed operations of respective units in the second embodiment include some adjustments different from those in the first embodiment.

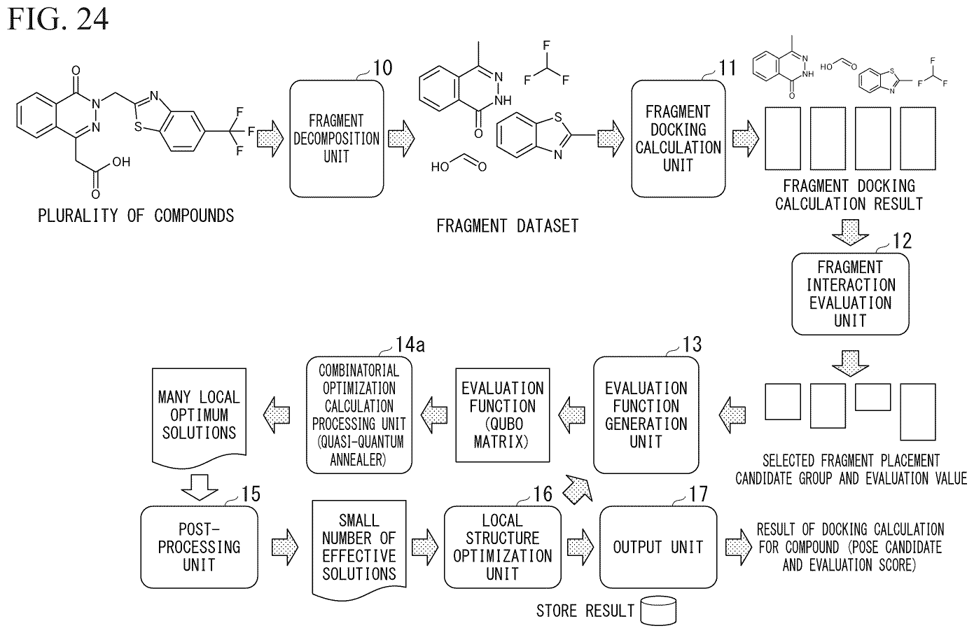

FIG. 24 is a diagram showing an example of the processing content of respective functional units of the calculation processing device 1a according to the present embodiment. In the present embodiment, the input fragments are not fragments obtained by decomposing one compound, but a fragment set, which is a set of fragments corresponding to a plurality of compounds, is used as an input. The fragment set is preferably a diverse set of fragments corresponding to a broad compound space (a set of compounds). The fragment set is obtained, for example, by decomposing a plurality of compounds. The compound dataset 20a is data indicating the compound group. The fragment decomposition unit 10 generates a fragment dataset by sequentially decomposing a plurality of these compounds into fragments. In this case, when the number of compounds increases, it is expected that many fragments common to a plurality of compounds will be generated. In the present embodiment, it is important that the commonality of these fragments contribute to improving the efficiency of the entire process.

The subsequent processing content is generally similar to that in the first embodiment, but there are three main differences from the first embodiment.

The first difference is a difference in the design of the Hamiltonian generated by the evaluation function generation unit 13. In the first embodiment, since it is clear that each fragment obtained by decomposing the input compound would be used exactly once, a one-hot constraint is introduced in the fourth term H₄. On the other hand, in the present embodiment, most fragments are not used, with only a small number of fragments selected from the fragment dataset actually being used and the rest not being used. Accordingly the weighting of the one-hot constraint is reduced, and instead, a term indicating a constraint on the total number of fragments allowed is introduced into the Hamiltonian. A similar idea is described in Non-Patent Document 5 in the context of solving polyomino puzzles, and a specific Hamiltonian designing method is also provided, and thus the same method can be used.

The second difference is that, in the present embodiment, there may be a larger number of solutions compared to the first embodiment. The combinatorial optimization calculation processing unit 14a calculates a fragment pose set by combinatorial optimization based on an evaluation function for fragment data obtained from a plurality of compounds. In this case, among a plurality of input compounds, there may be a plurality of compounds that can yield favorable docking calculation results considered as correct, and furthermore, a completely new compound formed by combining fragments obtained from a plurality of compounds may also yield favorable docking calculation results. Consequently when an information processing device that simply obtains only one solution is used in the combinatorial optimization calculation processing unit 14a, there is a risk of overlooking diverse solutions.

Thus in order to cover diverse solutions, it is preferable to use a quasi-quantum annealer having a function of obtaining many local optimum solutions. As a quasi-quantum annealer with an excellent ability to cover diverse solutions, for example, SQBM+ (commercially available from Toshiba Digital Solutions Corporation) described in the first embodiment is preferable. In addition, as described in the first embodiment, the diversity of solutions can also be expanded in the present embodiment by changing the weights of the terms in the Hamiltonian or changing the criteria for determining collision and cooperation.

Here, in the present embodiment, in the linear evaluation process performed by the fragment interaction evaluation unit 12, furthermore, a bias is introduced to set higher linear evaluation values for specific fragments, that is, to prioritize the adoption of specific fragments. For example, for many fragments, a positive linear bias is applied to fragments that the user is particularly expecting based on pharmaceutical knowledge and the like. In another example, when combinatorial optimization calculation is performed while mechanically and sequentially changing the target fragment to which a bias is applied, compounds containing the target fragment are preferentially identified, and it is easier to obtain diverse solutions overall. When such information processing is repeatedly executed based on an operation from the user or automatically, or executed in parallel using many quasi-quantum annealers, it is possible to realize the evaluation of various compounds.

The third difference is that, in the present embodiment, instead of decomposing a plurality of compounds by the fragment decomposition unit 10 to obtain a fragment dataset, a fragment dataset that is highly convenient for the user is prepared in advance, and the function of the fragment decomposition unit 10 can be realized by reading the fragment dataset from a file or the like. As the fragment dataset prepared in advance, for example, a fragment set that is frequently used in a pharmaceutical company may be selected or a fragment set that is designed and distributed for a broader range of users may be selected.

Here, in the first embodiment, it is also assumed that the fragment decomposition of compounds is stored in a database in advance, but the effect of this is limited to the effect of shortening the calculation time for relatively lightweight calculation of fragment decomposition for a single target compound. On the other hand, the present embodiment significantly differs in that a fragment set including many representative fragments is input to obtain the docking calculation results of a plurality of compounds at once. In this case, the selection of the fragment set affects the results.

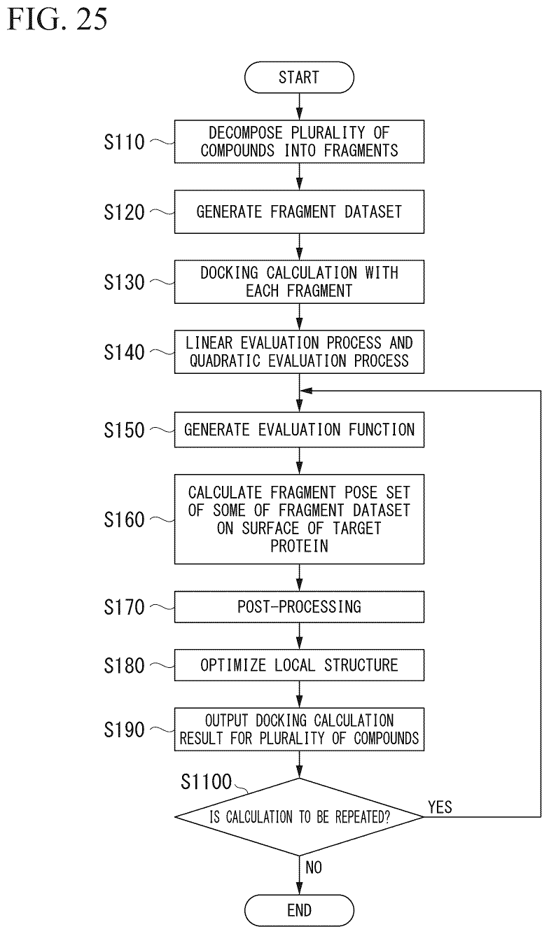

FIG. 25 is a diagram showing an example of a flow of a fragment-based compound docking calculation process according to the present embodiment. Here, since the processes of Step S130, Step S140, Step S150, Step S170, Step S180, and Step S1100 are the same as the processes of Step S30, Step S40, Step S50, Step S70, Step S80, and Step S100 in FIG. 7, descriptions thereof will be omitted.

Step S110: The fragment decomposition unit 10 decomposes a plurality of compounds into fragments. As an example, the fragment decomposition unit 10 reads data on a plurality of compounds designated by the user from the compound dataset 20a stored in the storage unit 2. The fragment decomposition unit 10 sequentially decomposes a plurality of compounds into fragments based on the read compound data.

Step S120: In addition, the fragment decomposition unit 10 generates a fragment dataset based on the decomposition processing result. The fragment dataset is a combination of fragment data indicating fragments that are substructures for a plurality of compounds.

Here, in Step S110 and Step S120, when a file of a fragment set is stored in advance instead of the compound dataset 20a in the storage unit 2, it is possible to omit the decomposition processing and directly use the read fragment set. The compound dataset 20a can be calculated efficiently if a group of compounds that are predicted in advance to have high binding affinity (excellent docking score) with the target protein can be collected. Even when the fragment set is directly read instead of compounds, efficiency can be improved by collecting fragment groups predicted to be readily selected. It is desirable to utilize general knowledge in drug discovery science or prior information about the target protein to efficiently select these datasets.

Step S160: The combinatorial optimization calculation processing unit 14a calculates a fragment pose set of the fragment dataset on the surface of the target protein based on the evaluation function generated by the evaluation function generation unit 13. As described above, the fragment pose set may include the results of fragment docking calculation between a plurality of fragments, which are substructures of a plurality of mutually different compounds, and target proteins. Hence, the combinatorial optimization calculation processing unit 14a calculates, based on the evaluation function generated by the evaluation function generation unit 13, a fragment pose set of a plurality of fragments, which are substructures of a plurality of mutually different compounds, on the surface of the target protein.

Step S190: The output unit 17 outputs the docking calculation result for the compound group. The output unit 17 outputs, for example, the result to an external device (a server, a display device, etc.) separate from the calculation processing device 1a.

This concludes the description of the flow of the fragment-based compound docking calculation process according to the present embodiment.

Here, in the above embodiments, an example in which the result of docking calculation between the compound and the target protein is obtained by determining a state that optimizes the Hamiltonian based on combinatorial optimization using the QUBO matrix has been described, but the present invention is not limited thereto. The Hamiltonian may be optimized based on an optimization algorithm other than the combinatorial optimization using the QUBO matrix.

For example, the fragment interaction evaluation unit 12 may perform one or more of a tertiary evaluation process and a fourth evaluation process in addition to the above linear evaluation process and quadratic evaluation process. The tertiary evaluation process is a process of evaluating collision and cooperation between three fragment placement candidates. The fourth evaluation process is a process of evaluating collision and cooperation between four fragment placement candidates. Increasing the order of the evaluation process increases the number of fragment placement candidate triplets or quadruplets to be evaluated, and consequently, leads to an increase in the computational complexity. However, by considering features that are particularly important for solving the problem, it is possible to improve the quality of the solution to the problem. Here, when a third-order or higher evaluation process is performed, the method known as polynomial unconstrained binary optimization (PUBO) is used instead of quadratic unconstrained binary optimization (QUBO), but the essential configuration remains unchanged from the above embodiments.

Here, some units of the calculation processing devices 1 or 1a in each of the above embodiments, for example, the fragment decomposition unit 10, the fragment docking calculation unit 11, the fragment interaction evaluation unit 12, the evaluation function generation unit 13, the combinatorial optimization calculation processing unit 14 or 14a, the post-processing unit 15, the local structure optimization unit 16, and the output unit 17 may be realized by a computer. In this case, a program for realizing this control function is recorded in a computer readable recording medium, and a computer system reads and executes the program recorded in the recording medium for realization. Note that the “computer system” here is a computer system built into the calculation processing device 1 or 1a, and includes an operating system (OS) and hardware such as peripheral devices. In addition, the “computer readable recording medium” refers to a portable medium such as a flexible disk, a magneto optical disc, a read only memory (ROM) and a compact disc-read only memory (CD-ROM), and a storage device such as a hard disk built into a computer system. In addition, the “computer readable recording medium” may include a medium that dynamically maintains a program for a short time like a communication line when a program is transmitted via a network such as the Internet or a communication line such as a telephone line and a medium that maintains a program for a certain time like a volatile memory in the computer system serving as a server or a client in that case. In addition, the program may be a program for realizing some of the above functions and may be capable of realizing the above functions in combination with a program already recorded in the computer system.

In addition, a part or all of the calculation processing device 1 or 1a in the above embodiment may be realized as an integrated circuit such as an large scale integration (LSI). The functional blocks of the calculation processing device 1 or 1a may be individually implemented as a processor or some or all thereof may be integrally implemented as a processor. In addition, a method of forming an integrated circuit is not limited to an LSI, and this may be realized by a dedicated circuit or a general-purpose processor. In addition, when a technology for forming an integrated circuit that replaces the LSI appears according to the advance of semiconductor technology, an integrated circuit based on the technology may be used.

While embodiments of the present invention have been described above in detail with reference to the drawings, the specific configuration is not limited to the above embodiment, and various design changes and the like can be made without departing from the spirit and scope of the invention.

### EXPLANATION OF REFERENCES

1, 1a Calculation processing device (compound docking calculation processing device)
10 Fragment decomposition unit
11 Fragment docking calculation unit
12 Fragment interaction evaluation unit
13 Evaluation function generation unit
14, 14a Combinatorial optimization calculation processing unit

What is claimed is:

1. A compound docking calculation processing device, comprising:
a fragment decomposition unit configured to acquire fragment data indicating fragments, which are chemical substructures of a compound used to perform docking calculation with a target biomolecule;
a fragment docking calculation unit configured to execute, for each fragment indicated by the fragment data, fragment docking calculation between the fragment and the target biomolecule;
a fragment interaction evaluation unit configured to calculate, based on the result of fragment docking calculation for each fragment placement candidate which is a placement candidate when the fragment binds to the target biomolecule and a positional relationship between the fragment placement candidates, evaluation values for the fragment placement candidates and the interrelationship between the fragment placement candidates;
an evaluation function generation unit configured to generate an evaluation function of giving an evaluation value for a fragment pose set of the fragments constituting the compound on the surface of the target biomolecule based on the evaluation value; and
a combinatorial optimization calculation processing unit configured to calculate a fragment pose set of the fragments constituting the compound on the surface of the target biomolecule by determining a state that optimizes the evaluation function based on combinatorial optimization.

2. The compound docking calculation processing device according to claim 1, wherein the positional relationship between the fragment placement candidates includes collision between the fragment placement candidates, and
the fragment interaction evaluation unit calculates the evaluation value for the collision between the fragment placement candidates.

3. The compound docking calculation processing device according to claim 1,
wherein the positional relationship between the fragment placement candidates includes the cooperation between the fragment placement candidates, and
the fragment interaction evaluation unit calculates the evaluation value for the cooperation between the fragment placement candidates.

4. The compound docking calculation processing device according to claim 1, wherein the fragment interaction evaluation unit calculates the evaluation value for the binding of each of the fragment placement candidates to the target biomolecule based on the fragment docking score for each of the fragment placement candidates.

5. The compound docking calculation processing device according to claim 4, wherein the fragment interaction evaluation unit calculates the evaluation value for the binding of each of the fragment placement candidates to the target biomolecule based on the size of the fragment corresponding to the fragment placement candidate and the fragment docking score for the fragment placement candidate.

6. The compound docking calculation processing device according to claim 1, wherein the evaluation function is a Hamiltonian.

7. The compound docking calculation processing device according to claim 6, wherein the combinatorial optimization calculation processing unit calculates the fragment pose set by determining a state that minimizes the Hamiltonian based on unconstrained binary variable optimization.

8. The compound docking calculation processing device according to claim 6, wherein the Hamiltonian includes a constraint condition indicating that each fragment is selected once as the fragment placement candidate.

9. The compound docking calculation processing device according to claim 1, wherein the fragment decomposition unit acquires fragment data indicating a set of fragments corresponding to a plurality of compounds.

10. The compound docking calculation processing device according to claim 9, wherein the fragment docking calculation unit outputs the result of fragment docking calculation between each fragment and the target biomolecule for the fragment indicated by the fragment data indicating a set of fragments corresponding to the plurality of compounds.

11. The compound docking calculation processing device according to claim 10, wherein the combinatorial optimization calculation processing unit calculates, based on the evaluation function, a fragment pose set of fragments constituting the plurality of mutually different compounds on the surface of the target biomolecule.

12. The compound docking calculation processing device according to claim 1, further comprising:
a post-processing unit configured to perform post-processing on the fragment pose set;
a local structure optimization unit configured to perform local structure optimization processing on a molecular structure indicated by the post-processing result; and
an output unit configured to output the result of docking calculation between the compound and the target biomolecule from the local structure optimization result.

13. A compound docking calculation processing method, comprising:
a fragment decomposition step of acquiring fragment data indicating fragments, which are chemical substructures of a compound used to perform docking calculation with a target biomolecule;
a fragment docking calculation step of executing, for each fragment indicated by the fragment data, fragment docking calculation between the fragment and the target biomolecule;
a fragment interaction evaluation step of calculating, based on the result of fragment docking calculation for each fragment placement candidate which is a placement candidate when the fragment binds to the target biomolecule and a positional relationship between the fragment placement candidates, evaluation values for the fragment placement candidates and the interrelationship between the fragment placement candidates;
an evaluation function generation step of generating an evaluation function of giving an evaluation value for a fragment pose set of the fragments constituting the compound on the surface of the target biomolecule based on the evaluation value; and
a combinatorial optimization calculation processing step of calculating a fragment pose set of the fragments constituting the compound on the surface of the target biomolecule by determining a state that optimizes the evaluation function based on combinatorial optimization.

14. A program causing a computer to execute:
a fragment decomposition step of acquiring fragment data indicating fragments, which are chemical substructures of a compound used to perform docking calculation with a target biomolecule;
a fragment docking calculation step of executing, for each fragment indicated by the fragment data, fragment docking calculation between the fragment and the target biomolecule;
a fragment interaction evaluation step of calculating, based on the result of fragment docking calculation for each fragment placement candidate which is a placement candidate when the fragment binds to the target biomolecule and a positional relationship between the fragment placement candidates, evaluation values for the fragment placement candidates and the interrelationship between the fragment placement candidate;
an evaluation function generation step of generating an evaluation function of giving an evaluation value for a fragment pose set of the fragments constituting the compound on the surface of the target biomolecule based on the evaluation value; and
a combinatorial optimization calculation processing step of calculating a fragment pose set of the fragments constituting the compound on the surface of the target biomolecule by determining a state that optimizes the evaluation function based on combinatorial optimization.
